(19) United States
(12) Patent Application Publication
(10) Pub. No.: US 2015/0234782 A1
(43) Pub. Date: Aug. 20, 2015

(54) CALCULATION DEVICE AND METHOD, AND COMPUTER PROGRAM PRODUCT

(71) Applicant: KABUSHIKI KAISHA TOSHIBA, Tokyo (JP)

(72) Inventor: Satoshi Ito, Kawasaki (JP)

(21) Appl. No.: 14/613,516

(22) Filed: Feb. 4, 2015

(30) Foreign Application Priority Data
Feb. 20, 2014 (JP) 2014-030965

(51) Int. Cl. G06F 17/16; G06F 17/50

(52) U.S. Cl. CPC G06F 17/16; G06F 17/50

(57) ABSTRACT

According to an embodiment, a calculation device includes an acquisition unit, an extractor, a calculator, and an output unit. The acquisition unit acquires point cloud data that is a set of points representing a shape of an object. The extractor extracts a focus point from the point cloud data. The calculator calculates a distance between the focus point and each of one or more neighboring points located in the vicinity of the focus point, calculates relation information which represents a relationship, not the distance, between the focus point and each of the one or more neighboring points, calculates a co-occurrence frequency between the distance and the relation information for the one or more neighboring points, and determines the co-occurrence frequency as a descriptor of the focus point. The output unit outputs the descriptor.

### CROSS-REFERENCE TO RELATED APPLICATIONS

This application is based upon and claims the benefit of priority from Japanese Patent Application No. 2014-030965, filed on Feb. 20, 2014; the entire contents of which are incorporated herein by reference.

### FIELD

Embodiments described herein relate generally to calculation device and method, and a computer program product.

### BACKGROUND

A three-dimensional shape of an object is usually measured multiple times as it is difficult to measure the entire object in a single measurement. Since point cloud data obtained in each measurement has a different coordinate system in this case, the point cloud data are aligned to make the coordinate system common for all pieces of the point cloud data and integrate all pieces of the point cloud data.

Such alignment between pieces of point cloud data is performed by a known method in which a focus point such as a feature point is extracted from each piece of point cloud data so that the extracted focus points are associated with each other by comparing a descriptor of the focus point. In this method, the accuracy of association between the focus points depends on the descriptor.

The descriptor of the focus point expresses information of the vicinity of the focus point and can be expressed as a histogram that is created for each of three types of relative angles formed between each of one or more neighboring points and the focus point and connected, for example.

However, the descriptor in the aforementioned related art cannot fully express the information of the vicinity of the focus point and has poor expressiveness. Therefore, the alignment between the pieces of point cloud data is more likely to fail when the aforementioned descriptor is used because of the low accuracy of association between the focus points.

### BRIEF DESCRIPTION OF THE DRAWINGS

FIG. 1 is a block diagram illustrating an example of a calculation device according to a first embodiment;

FIG. 2 is a diagram illustrating an example of point cloud data according to the first embodiment;

FIG. 3 is a diagram illustrating an example of a focus point and one or more neighboring points according to the first embodiment;

FIG. 4 is a diagram illustrating an example of a method of calculating a distance and relation information between the focus point and the neighboring point according to the first embodiment;

FIG. 5 is a diagram illustrating another example of the method of calculating the relation information between the focus point and the neighboring point according to the first embodiment;

FIG. 6 is a diagram illustrating an example of a co-occurrence histogram of the distance and the relation information according to the first embodiment;

FIG. 7 is a diagram illustrating an example of the co-occurrence histogram of the distance and the relation information according to the first embodiment;

FIG. 8 is a flowchart illustrating an example of processes performed in the first embodiment;

FIG. 9 is a diagram illustrating a comparative example with respect to the first embodiment;

FIG. 10 is a block diagram illustrating an example of a calculation device according to a second embodiment;

FIG. 11 is a flowchart illustrating an example of processes performed in the second embodiment;

FIG. 12 is a block diagram illustrating an example of a calculation device according to a third embodiment;

FIG. 13 is a flowchart illustrating an example of processes performed in the third embodiment;

FIG. 14 is a block diagram illustrating an example of a calculation device according to a fourth embodiment;

FIG. 15 is a flowchart illustrating an example of processes performed in the fourth embodiment; and

FIG. 16 is a diagram illustrating an example of a hardware configuration of the calculation device according to each embodiment.

### DETAILED DESCRIPTION

According to an embodiment, a calculation device includes an acquisition unit, an extractor, a calculator, and an output unit. The acquisition unit acquires point cloud data that is a set of points representing a shape of an object. The extractor extracts a focus point front the point cloud data. The calculator calculates a distance between the focus point and each of one or more neighboring points located in the vicinity of the focus point, calculates relation information which represents a relationship, not the distance, between the focus point and each of the one or more neighboring points, calculates a co-occurrence frequency between the distance and the relation information for the one or more neighboring points, and determines the co-occurrence frequency as a descriptor of the focus point. The output unit outputs the descriptor.

Various embodiments will hereinafter be described in detail with reference to the drawings.

### First Embodiment

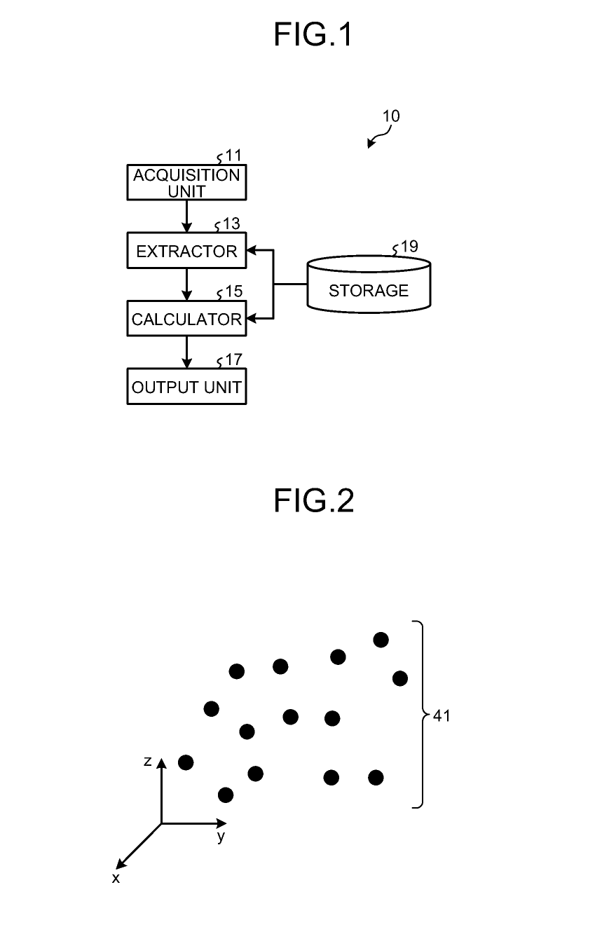

FIG. 1 is a block diagram illustrating an example of a calculation device 10 according to a first embodiment. As illustrated in FIG. 1, the calculation device 10 includes an acquisition unit 11, an extractor 13, a calculator 15, an output unit 17, and a storage 19. The acquisition unit 11, the extractor 13, the calculator 15, and the output unit 17 may be implemented by causing a processor such as a CPU (Central Processing Unit) to execute a program, namely by software, implemented by hardware such as an IC (Integrated Circuit), or implemented by a combination of the software and the hardware, for example. The storage 19 can be implemented by a storage such as an HDD (Hard Disk Drive), an SSD (Solid State Drive), a memory card, an optical disk, a ROM (Read Only Memory), or a RAM (Random Access Memory) which can store information magnetically, optically, or electrically.

The acquisition unit 11 acquires point cloud data that is a set of points representing a shape of an object.

Each point included in the point cloud data holds position information representing a position on a surface of the object. The position information is preferably a three-dimensional coordinate disposed in a three-dimensional Cartesian coordinate system but is not limited thereto. The position information may be a three-dimensional coordinate disposed in a coordinate system such as a three-dimensional polar coordinate system or a three-dimensional cylindrical coordinate system that can be converted to the three-dimensional Cartesian coordinate system. When the position information is the three-dimensional coordinate disposed in the coordinate system that can be converted to the three-dimensional Cartesian coordinate system, it is preferred that the acquisition unit 11 converts the three-dimensional coordinate to a three-dimensional coordinate disposed in the three-dimensional Cartesian coordinate system.

FIG. 2 is a diagram illustrating an example of point cloud data 41 according to the first embodiment, the point cloud data corresponding to a part of the object that is not shown. In the example illustrated in FIG. 2, the position information of each point included in the point cloud data 41 is a three-dimensional coordinate disposed in the three-dimensional Cartesian coordinate system.

Note that the point cloud data acquired by the acquisition unit 11 may be generated by three-dimensional measurement using a laser sensor or a stereo camera, or by software such as 3D-CAD (Computer Aided Design).

Each point included in the point cloud data acquired by the acquisition unit 11 may also include information besides the position information. When the point cloud data is generated by the three-dimensional measurement using an active sensor, for example, the point cloud data can further include reflection intensity of each point. When the point cloud data is generated by the three-dimensional measurement using a visible light camera, for example, the point cloud data can further include a luminance value of each point. When the point cloud data is generated by the three-dimensional measurement using a color camera, for example, the point cloud data can further include color information (RGB values) of each point. When the point cloud data is generated by the three-dimensional measurement performed in a time series while using the laser sensor or the stereo camera, for example, the point cloud data can further include a confidence level of each point. The confidence level represents the confidence that a point actually exists in that location. When the point cloud data is generated by the three-dimensional measurement employing a photometric stereo method with use of the laser sensor or the stereo camera, for example, the point cloud data can further include a normal vector of each point. When the point cloud data is generated by the 3D-CAD, for example, the point cloud data can further include information held in a 3D model such as color information and material information of each point.

The extractor 13 extracts a focus point from the point cloud data acquired by the acquisition unit 11. The focus point may be a point specified in advance by a user or a feature point. When the focus point is the point that is specified in advance, the extractor 13 extracts the point specified in advance from the point cloud data. When the focus point is the feature point, the extractor 13 uses a known feature point detection method to extract the feature point from the point cloud data. The known feature point detection method can be a method described in “A Performance Evaluation of 3D Keypoint Detectors,” S. Salti et al., 2011, for example.

Note that a parameter used by the extractor 13 to extract the focus point is stored in the storage 19. The extractor 13 uses this parameter to extract the focus point from the point cloud data. The parameter used to extract the focus point can be a piece of information indicating the point specified in advance or a parameter used to detect the feature point, for example.

The calculator 15 calculates a descriptor which expresses information of the vicinity of the focus point extracted by the extractor 13. The descriptor is used when the point cloud data acquired by the acquisition unit 11 is aligned with another point cloud data. Specifically, the descriptor is a numerical form of local information around the focus point and is typically represented by a real number vector in many cases. Note that the alignment of the point cloud data will not be described in the first embodiment but will be in a second embodiment.

Here, there will be described a requirement pertaining to the descriptor in performing the alignment between pieces of the point cloud data.

First, it is required that the descriptor do not depend on the coordinate system which determines the position of each point included in the point cloud data.

It is assumed that the object is a cone, the point cloud data is a set of each point on the surface of the cone, and the focus point is an apex of the cone, for example. In this case, it is required that the descriptor of the focus point (apex) have the same value regardless of whether a base of the cone lies in an x-y plane with a height direction corresponding to a z axis or the base of the cone lies in a y-z plane with the height direction corresponding to an x axis.

This is because pieces of point cloud data have different coordinate systems when aligning the pieces of point cloud data together. Specifically, when the value of the descriptor differs depending on the coordinate system, the descriptor of the focus point of the point cloud data acquired by the acquisition unit 11 has a different value from the descriptor of the focus point of another point cloud data even when the focus point of the point cloud data acquired by the acquisition unit 11 is identical to the focus point of the other point cloud data, whereby the alignment between the pieces of point cloud data results in a failure.

Secondly, it is required that the descriptor possess high expressiveness.

The descriptor possessing the high expressiveness takes approximately the same value when the shape of the vicinity of the focus point (such as a positional relationship between the focus point and one or more neighboring points located in the vicinity of the focus point) is approximately the same, but takes a different value when the shape of the vicinity of the focus point differs.

It is therefore not preferred to set the number of neighboring points located in the vicinity of the focus point as the descriptor, for example. In such a case, the descriptor does not depend on the coordinate system of the point cloud data and therefore satisfies the first requirement, but does not satisfy the second requirement because the descriptor takes the same value when the number of neighboring points is the same even when the shape of the vicinity of the focus point (positional relationship between the focus point and the one or more neighboring points) differs.

Accordingly, the calculator 15 of the first embodiment calculates the descriptor satisfying the first and second requirements as the descriptor of the focus point extracted by the extractor 13. Specifically, the calculator 15 calculates a distance between the focus point extracted by the extractor 13 and each of the one or more neighboring points located in the vicinity of the focus point, calculates relation information which represents the relationship, not the distance, between the focus point and each of the one or more neighboring points, calculates a co-occurrence frequency between the distance and the relation information for the one or more neighboring points, and determines the co-occurrence frequency as the descriptor of the focus point.

Alternatively, the calculator 15 may calculate a plurality of types of relation information for each neighboring point, calculate the co-occurrence frequency for each of pieces of relation information of the same type, and determine the co-occurrence frequency of the plurality of types as the descriptor.

Specific description on how the descriptor is calculated will be provided below.

The neighboring point of the focus point will be described first.

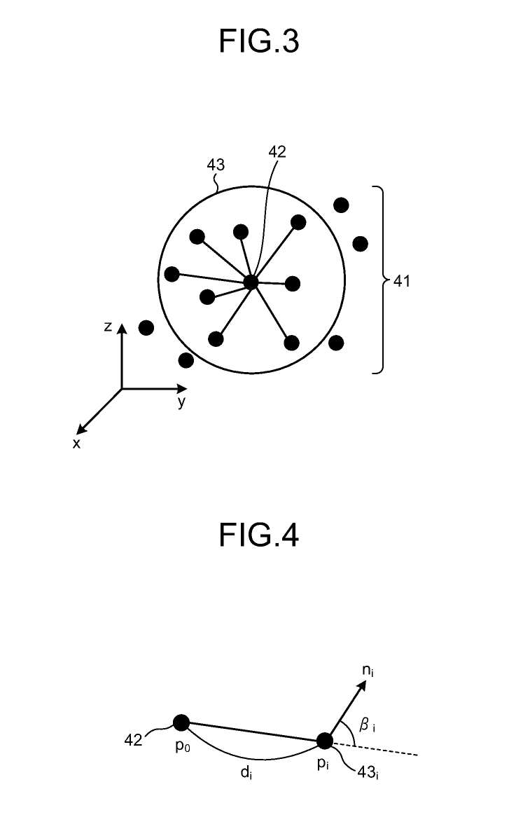

FIG. 3 is a diagram illustrating an example of a focus point 42 and one or more neighboring points 43 according to the first embodiment. In the example illustrated in FIG. 3, the calculator 15 determines, as the one or more neighboring points 43, one or more points having a distance equal to a threshold r or less from the focus point 42 which is extracted from point cloud data 41 by the extractor 13.

The threshold r may be set such that an actual measurement equals a predetermined value while considering the scale of a coordinate system of the point cloud data 41, for example. In this case, a common value is used as the threshold r in the point cloud data 41. Moreover, the threshold r may be set in accordance with an analysis result of the distribution of points around the focus point 42 using a known scale space method, for example. In this case, the threshold r takes a different value for each focus point in the point cloud data 41.

The threshold r may also be set such that, for example, the number n of one or more neighboring points 43 equals a preset number when the density of points in the point cloud data 41 is identical to the density of points in another point cloud data to be aligned with the point cloud data 41. In this case, the threshold r takes a value equal to a distance from the focus point 42 to an n-th closest point therefrom. However, it is not preferred to set the threshold r such that the number n of the one or more neighboring points 43 equals the preset number when the density of points in the point cloud data 41 is different from the density of points in the other point cloud data to be aligned with the point cloud data 41. This is because, in the first embodiment where the distance between the focus point and the neighboring point is used to calculate the descriptor as described above, the distance between the focus point and the neighboring point differs when the density of the points differs between the pieces of point cloud data, whereby the descriptor does not satisfy the second requirement.

Next, there will be described the distance and relation information between the focus point and the neighboring point as well as the co-occurrence frequency of the distance and the relation information.

It is assumed in the following description that P₀ denotes position information (a three-dimensional coordinate disposed in a three-dimensional Cartesian coordinate system) of the focus point 42, a neighboring point 43ᵢ represents an i-th neighboring point of the focus point 42, and pᵢ denotes position information (a three-dimensional coordinate disposed in the three-dimensional Cartesian coordinate system) of the neighboring point 43ᵢ. Moreover, the number of the neighboring points 43 equals “n” as described above, and “i” satisfies 1≦i≦n.

FIG. 4 is a diagram illustrating an example of a method of calculating the distance and the relation information between the focus point 42 and the neighboring point 43ᵢ according to the first embodiment.

The calculator 15 uses expression (1) to calculate a distance dᵢ (refer to FIG. 4) between the focus point 42 and the neighboring point 43ᵢ.

dᵢ=D(P₀,Pᵢ)=∥pᵢ−p₀∥ (1)

P₀ represents the focus point 42, and Pᵢ represents the neighboring point 43ᵢ.

The distance dᵢ does not depend on the coordinate system, and therefore, satisfies the first requirement. However, even when the frequency distribution of the distance dᵢ of each of the n neighboring points 43 is set as the descriptor, the distance dᵢ possesses the low expressiveness, and therefore, does not satisfy the second requirement.

Accordingly, in the first embodiment, the calculator 15 further calculates relation information v different from the distance d to determine the co-occurrence frequency between the distance d and the relation information v as the descriptor. The relation information v will be described in detail later. The descriptor is a co-occurrence frequency to thereby grasp how much relation information is generated at which distance as well as is not readily affected by the density of the points, and therefore has high expressiveness.

An example of the co-occurrence frequency between the distance d and the relation information v can be a co-occurrence histogram obtained by quantizing distance d into L_{d} gradations, quantizing the relation information v into Lᵥ gradations, and calculating the frequency at which the two co-occur. In this case, the co-occurrence histogram (descriptor) has L_{d}×L_{V} elements. Expression (2) represents a co-occurrence histogram H (s, t) where “s” denotes the quantized distance and “t” denotes the quantized relation information.

H(s,t)=#({PεN(P₀)|Q_{d}(P₀,P)=ŝQᵥ(P₀,P)=t})/n for s=0, . . . ,L_{d}−1,t=0, . . . ,Lᵥ−1 (2)

Here, N (P₀) represents a set of the n neighboring points of the focus point P₀, # (A) represents the number of elements in a set A, Q_{d} (P₀, P) represents a value of the distance between the focus point P₀ and the neighboring point P that is quantized into the L_{d} gradations, and Qᵥ (P₀, P) represents a value of the relation information between the focus point P₀ and the neighboring point P that is quantized into the Lᵥ gradations. Note that Q_{d} (P₀, P) is expressed by expression (3).

$${Q}_{d} ( {P}_{0} , P ) = floor ( ( {L}_{d} - 1 ) \frac{D ( {P}_{0} , {P}_{i} )}{r} ) \qquad ( 3 )$$

Here, floor (x) represents a floor function which returns a maximum integer not exceeding x.

Moreover, Qᵥ (P₀, P) is set in the same manner as Q_{d} (P₀, P).

While the co-occurrence histogram expressed by expression (2) ignores a quantization error of the distance and the relation information and votes for the closest bin, the quantization error may be considered as well. There may be performed, for example, a weighted vote to four neighboring bins instead of voting for only the closest bin of the co-occurrence histogram. A value obtained by performing linear interpolation according to the magnitude of the quantization error may be used as the weight of voting, for example.

Moreover, the calculator 15 may calculate not just one type but a plurality of types of the relation information. When the plurality of types of the relation information is calculated with “M” indicating the number of types, the calculator 15 calculates M co-occurrence frequencies between the distance and the relation information. Those M pieces of co-occurrence frequencies may be connected to be used as the descriptor.

Here, the relation information between the focus point and the neighboring point will be described in detail.

An example of the relation information can be a quantity based on an angle βᵢ (refer to FIG. 4) formed between a displacement vector (pᵢ−p₀) from the focus point 42 to the neighboring point 43ᵢ and a normal vector nᵢ of the neighboring point 43ᵢ. For example, “βᵢ” itself may be the relation information, “γᵢ” obtained by converting “βᵢ” with expression (4) may be the relation information, or a value obtained by converting “βᵢ” with a cosine function may be the relation information.

γᵢ=min(β₁,π−βᵢ) (4)

Here, “n” represents a circumference ratio. Note that “γᵢ” represents the angle formed when each of the displacement vector (pᵢ−p₀) and the normal vector nᵢ is regarded as a straight line.

When each point included in the point cloud data does not have information on the normal vector, for example, the calculator 15 may perform local plane fitting on each point and determine a unit vector in the direction perpendicular to the fitted plane as the normal vector at that point. Alternatively, the calculator 15 may use another normal estimation method to calculate the normal vector, for example.

Another example of the relation information can be similarity between a feature quantity of the focus point 42 and a feature quantity of the neighboring point 43ᵢ. The feature quantity can be a piece of information on each point included in the point cloud data 41. A preferred example of the feature quantity is the normal vector.

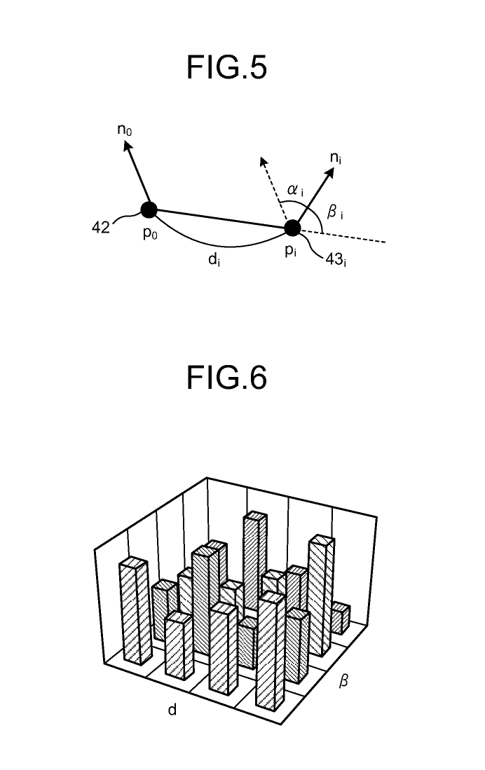

FIG. 5 is a diagram illustrating another example of a method of calculating the relation information between the focus point 42 and the neighboring point 43ᵢ according to the first embodiment. In the example illustrated in FIG. 5, an angle αᵢ formed between a normal vector n₀ of the focus point 42 and a normal vector nᵢ of the neighboring point 43ᵢ is the similarity (relation information) of the feature quantity.

In this case, the calculator 15 eliminates the neighboring point with which the angle αᵢ is an obtuse angle, namely uses the neighboring point with which the angle αᵢ is not the obtuse angle, and calculates the co-occurrence histogram between the distance d and the relation information v (angle α) to be used as the descriptor. This is to eliminate the co-occurrence between the front and back sides of an object on which the focus point 42 and the neighboring point 43ᵢ are possibly located, respectively, when the angle αᵢ is the obtuse angle. In the three-dimensional measurement, the front and back sides of the object cannot be measured at the same time in many cases, whereby such elimination is effective as the co-occurrence between the front and back sides is regarded an unreliable piece of information. Note that the feature quantity is not limited to the normal vector but may be information such as the reflection intensity, the luminance value, and the RGB value included in each point of the point cloud data 41, or may be a known feature quantity such as SpinImage, for example.

When the feature quantity is represented as a vector, the calculator 15 uses a criterion such as an Euclidean distance (L2 distance), a Manhattan distance (L1 distance), cosine similarity, and an angle formed between the feature quantities to calculate the similarity between the feature quantity of the focus point 42 and the feature quantity of the neighboring point 43ᵢ.

Alternatively, the calculator 15 may calculate dissimilarity instead of the similarity between the feature quantity of the focus point 42 and the feature quantity of the neighboring point 43ᵢ. The similarity can be obtained by inverting the sign of the dissimilarity.

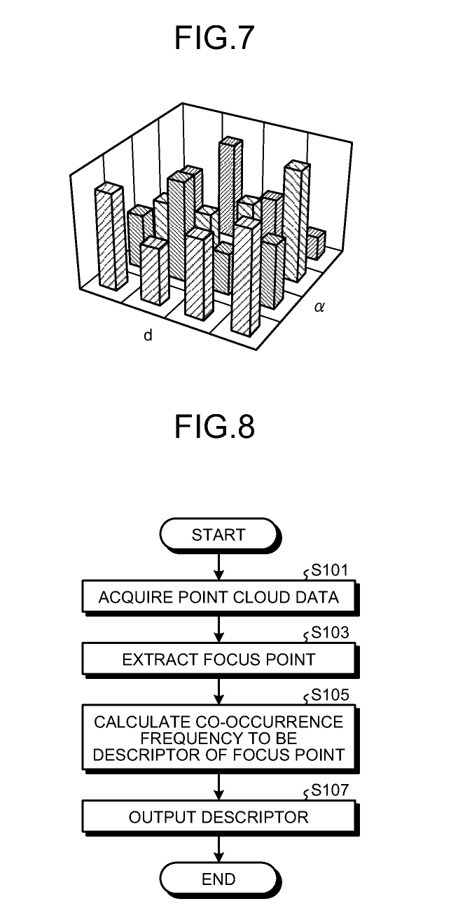

FIGS. 6 and 7 are diagrams each illustrating an example of the co-occurrence histogram of the distance and the relation information according to the first embodiment. When the quantity based on the angle βᵢ (such as βᵢ itself) is the relation information, for example, the calculator 15 calculates the co-occurrence histogram of the distance d and the angle β (relation information v), as illustrated in FIG. 6, to be used as the descriptor of the focus point 42. When the angle αᵢ is the relation information, for example, the calculator 15 calculates the co-occurrence histogram of the distance d and the angle α (relation information v), as illustrated in FIG. 7, to be used as the descriptor of the focus point 42. When the angles βᵢ and αᵢ are the relation information, for example, the calculator 15 calculates the co-occurrence histogram of the distance d and the angle β (relation information v) as illustrated in FIG. 6 and the co-occurrence histogram of the distance d and the angle α (relation information v) as illustrated in FIG. 7, and connects these co-occurrence histograms to be used as the descriptor.

A parameter used by the calculator 15 to calculate the descriptor is stored in the storage 19. The calculator 15 uses this parameter to calculate the descriptor of the focus point. The parameter used to calculate the focus point can be a parameter indicating a value of or method of determining the threshold r, or a parameter indicating which information is to be used as the relation information, for example.

The output unit 17 outputs the descriptor calculated by the calculator 15.

FIG. 8 is a flowchart illustrating an example of the flow of processes performed by the calculation device 10 of the first embodiment.

First, the acquisition unit 11 acquires the point cloud data (step S101).

The extractor 13 then extracts the focus point from the point cloud data acquired by the acquisition unit 11 (step S103).

Subsequently, the calculator 15 calculates the distance between the focus point extracted by the extractor 13 and each of the one or more neighboring points located in the vicinity of the focus point, calculates the relation information which represents the relationship, not the distance, between the focus point and each of the one or more neighboring points, calculates the co-occurrence frequency between the distance and the relation information for the one or more neighboring points, and determines the co-occurrence frequency as the descriptor of the focus point (step S105).

The output unit 17 then outputs the descriptor calculated by the calculator 15 (step S107).

According to the first embodiment, as described above, the expressiveness of the descriptor can be enhanced since the co-occurrence frequency of the distance between the one or more neighboring points and the focus point and the relation (relation information) between the one or more neighboring points and the focus point is determined as the descriptor of the focus point. The descriptor grasps how much relation information is generated at which distance as well as is not readily affected by the density of the points, and thus has high expressiveness.

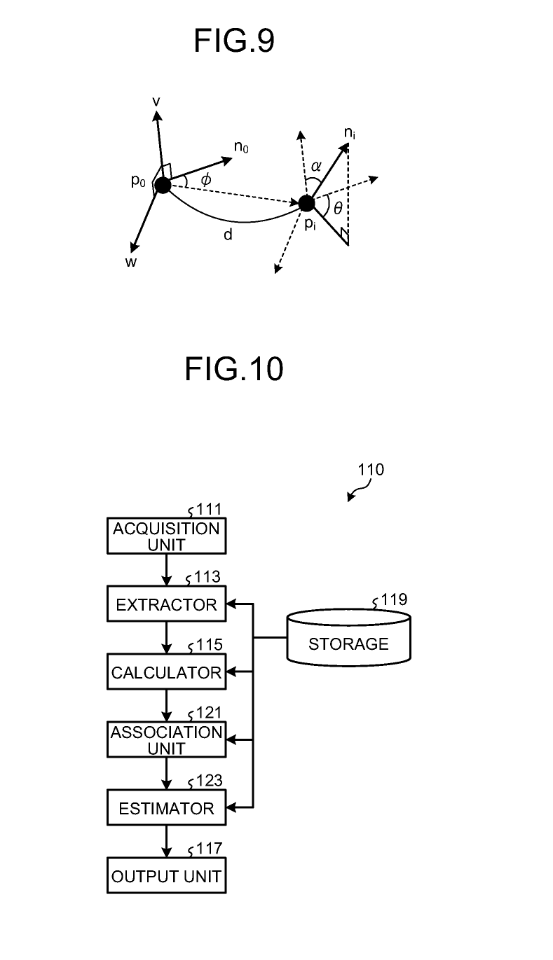

FIG. 9 is a diagram illustrating a comparative example with respect to the first embodiment and illustrates the descriptor according to a method disclosed in R. B. Rusu, N. Blodow and M. Beetz, “Fast Point Feature Histograms (FPFH) for 3D Registration, “Int. Conf. on Robotics and Automation, 2009 (referred to as Literature 1). In the method disclosed in Literature 1, three types of relative angles α, θ, and φ formed between the focus point and each of the one or more neighboring points are calculated so that each of the relative angles α, θ, and φ is represented as a histogram, which is then connected to be used as the descriptor.

Accordingly, in the method disclosed in Literature 1, each of the relative angles α, θ, and φ is used independently to be represented as the histogram, whereby the expressiveness is low because the co-occurrence relation as described in the first embodiment cannot be expressed.

### Second Embodiment

In a second embodiment, there will be described an example where pieces of point cloud data are aligned together by using the descriptor calculated in the first embodiment. In the following, the differences from the first embodiment will mainly be described, while a component having the same function as that in the first embodiment will be assigned the same name and the same reference numeral as that of the first embodiment to omit the description of such component.

FIG. 10 is a block diagram illustrating an example of a calculation device 110 according to the second embodiment. As illustrated in FIG. 10, an acquisition unit 111, an extractor 113, a calculator 115, an output unit 117, a storage 119, an association unit 121, and an estimator 123 included in the calculation device 110 of the second embodiment are different from the first embodiment.

The acquisition unit 111 acquires first point cloud data and second point cloud data as the point cloud data by a method described in the first embodiment. The first point cloud data and the second point cloud data are acquired by different measurements and have different coordinate systems.

The extractor 113 uses the method described in the first embodiment to extract three or more first focus points from the first point cloud data acquired by the acquisition unit 111 as well as three or more second focus points from the second point cloud data acquired by the acquisition unit 111.

The three or more first focus points and the three or more second focus points are regarded as feature points in the second embodiment.

The calculator 115 uses the method described in the first embodiment to calculate, as a descriptor, a first descriptor for each first focus point extracted by the extractor 113 as well as a second descriptor for each second focus point extracted by the extractor 113.

The association unit 121 uses the three or more first descriptors and the three or more second descriptors calculated by the calculator 115 to associate the three or more first focus points extracted by the extractor 113 with the three or more second focus points extracted by the extractor 113. Association (matching) is the same as feature point matching used in the field of image processing, and thus the feature point matching can be used in this case.

Specifically, the association unit 121 calculates dissimilarity between each of the three or more first descriptors and each of the three or more second descriptors to associate the three or more first focus points with the three or more second focus points.

The association unit 121 for example checks, for each first descriptor, whether or not the dissimilarity smallest among the dissimilarities being calculated equals a predetermined threshold or less and, when the dissimilarity equals the predetermined threshold or less, associates the first focus point of the first descriptor with the second focus point of the second descriptor with which the first descriptor has the smallest dissimilarity.

Moreover, the association unit 121 for example checks, for each first descriptor, whether or not a ratio (s1/s2) of dissimilarity s1 smallest among the dissimilarities being calculated to second smallest dissimilarity s2 equals a predetermined threshold or less and, when the ratio equals the predetermined threshold or less, associates the first focus point of the first descriptor with the second focus point of the second descriptor with which the first descriptor has the smallest dissimilarity.

Here, the association unit 121 may further perform matching (association) of the first focus point corresponding to the second focus point in addition to the aforementioned matching (association) of the second focus point corresponding to the first focus point, and confirm the association between the first focus point and the second focus point when the two matching results coincide with each other. Note that the association between the first focus point and the second focus point may be discarded when the two matching results do not coincide with each other.

A parameter used by the association unit 121 to perform association is stored in the storage 119. The association unit 121 uses this parameter to perform the association. The parameter used in the association can be a parameter indicating a predetermined threshold, for example.

The estimator 123 uses three or more pairs of the first focus points and the second focus points associated by the association unit 121 to estimate information on coordinate conversion from the coordinate system of the first point cloud data to the coordinate system of the second point cloud data.

The estimation of the coordinate conversion is a minimization problem expressed in expression (5) where “pⱼ” and “qⱼ” represent position information of the first focus point and the second focus point of a j-th pair, respectively. The minimization problem in expression (5) can be minimized by employing a known optimization methodology.

$$E ( S , R , t ) = {\sum }_{j} {‖ {q}_{j} - S ( {R}_{{p}_{j}} + t ) ‖}^{2} \qquad ( 5 )$$

Here, “S” represents a diagonal matrix converting the scale of the coordinate system, “R” represents a rotation matrix, and “t” represents a translation vector. When the first point cloud data and the second point cloud data have the same scale, “S” is an identity matrix and may be excluded from the parameter.

Considering a case where the pair of the first focus point and the second focus point is erroneously associated by the association unit 121, the estimator 123 may estimate the information on the coordinate conversion by using a RANSAC (RANdom SAmple Consensus) or the like. The RANSAC is an optimization method used against data including an outlier (erroneous association).

When less than three pairs of the first focus point and the second focus point are associated by the association unit 121, the estimator 123 cannot estimate the information on the coordinate conversion. In such a case, a report unit (not shown) may send such report. The report unit can be implemented by a display or a lamp, for example.

A parameter used by the estimator 123 to perform estimation is stored in the storage 119. The estimator 123 uses this parameter to perform the estimation. The parameter used for the estimation can be a parameter used in expression (5) or a parameter used in the RANSAC, for example.

The output unit 117 outputs the information on the coordinate conversion that is estimated by the estimator 123.

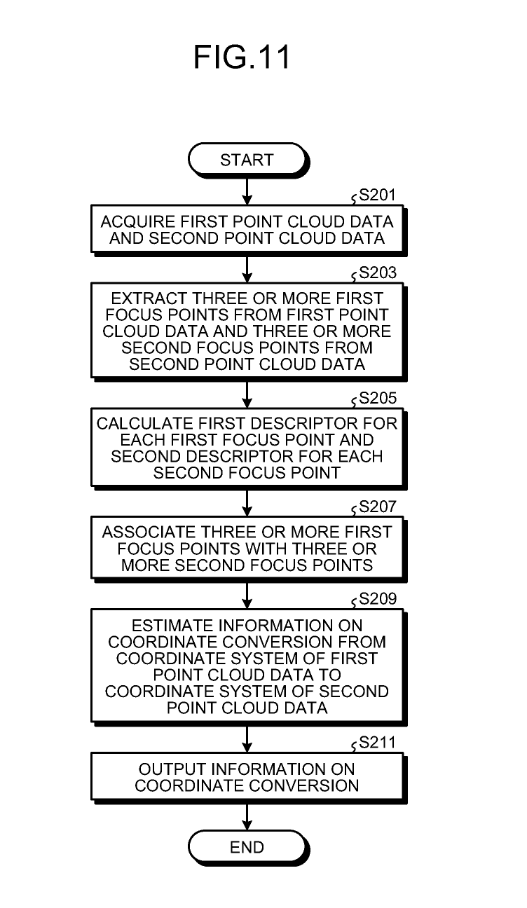

FIG. 11 is a flowchart illustrating an example of the flow of processes performed by the calculation device 110 of the second embodiment.

First, the acquisition unit 111 acquires the first point cloud data and the second point cloud data (step S201).

The extractor 113 then extracts the three or more first focus points from the first point cloud data acquired by the acquisition unit 111 as well as the three or more second focus points from the second point cloud data acquired by the acquisition unit 111 (step S203).

Subsequently, the calculator 115 calculates the first descriptor for each first focus point extracted by the extractor 113 as well as the second descriptor for each second focus point extracted by the extractor 113 (step S205).

The association unit 121 thereafter uses the three or more first descriptors and the three or more second descriptors calculated by the calculator 115 to associate the three or more first focus points extracted by the extractor 113 with the three or more second focus points extracted by the extractor 113 (step S207).

Next, the estimator 123 uses three or more pairs of the first focus points and the second focus points associated by the association unit 121 to estimate the information on the coordinate conversion from the coordinate system of the first point cloud data to the coordinate system of the second point cloud data (step S209).

Next, the output unit 117 outputs the information on the coordinate conversion that is estimated by the estimator 123 (step S211).

According to the second embodiment, as described above, the descriptor calculated by the method described in the first embodiment is used to associate pieces of point cloud data together, so that the focus points can be associated more accurately and that the alignment between the point cloud data can more easily result in a success.

### Third Embodiment

In a third embodiment, there will be described an example of improving the accuracy of the alignment described in the second embodiment. In the following, the differences from the second embodiment will mainly be described, while a component having the same function as that in the second embodiment will be assigned the same name and the same reference numeral as that of the second embodiment to omit the description of such component.

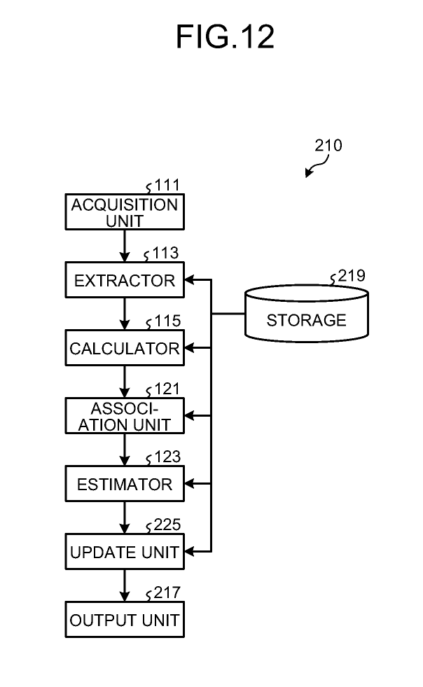

FIG. 12 is a block diagram illustrating an example of a calculation device 210 according to the third embodiment. As illustrated in FIG. 12, an output unit 217, a storage 219, and an update unit 225 included in the calculation device 210 of the third embodiment are different from the second embodiment.

The update unit 225 updates information on coordinate conversion that is estimated by an estimator 123 in such a manner to reduce the alignment error between first point cloud data and second point cloud data. Specifically, the update unit 225 uses information other than a pair of a first focus point and a second focus point associated by an association unit 121 to update the information on the coordinate conversion that is estimated by the estimator 123.

The update unit 225 for example uses the information on the coordinate conversion estimated by the estimator 123 as a default value and applies an ICP method (Iterative Closest Point) to the first point cloud data and the second point cloud data to update the information on the coordinate conversion in such a way that the alignment error between the first point cloud data and the second point cloud data is reduced. A known error may be used as the alignment error used in the ICP method. A point-to-point error expressed as a square distance between a point and another point or a point-to-plane error expressed as a square distance between a point and a plane may be used as the alignment error, for example.

A parameter used by the update unit 225 to perform update is stored in the storage 219. The update unit 225 uses this parameter to perform the update. The parameter used in the update can be a parameter used in the ICP method, for example.

The output unit 217 outputs the information on the coordinate conversion that is updated by the update unit 225.

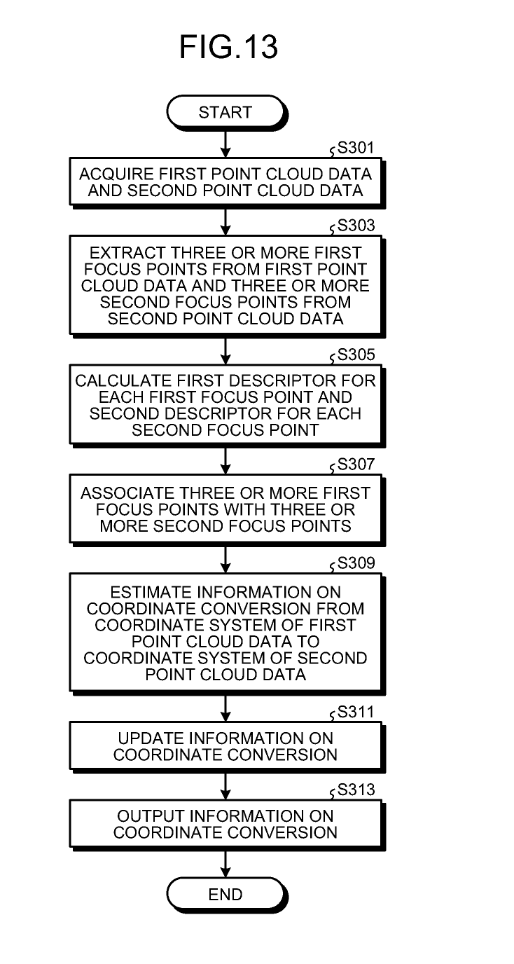

FIG. 13 is a flowchart illustrating an example of the flow of processes performed by the calculation device 210 of the third embodiment.

Processes performed in steps S301 to S309 are the same as the processes performed in steps S201 to S209 of the flowchart illustrated in FIG. 11, respectively.

Subsequently, the update unit 225 updates the information on the coordinate conversion that is estimated by the estimator 123 in such a manner to reduce the alignment error between the first point cloud data and the second point cloud data (step S311).

Next, the output unit 217 outputs the information on the coordinate conversion that is updated by the update unit 225 (step S313).

According to the third embodiment, as described above, the accuracy of alignment can be improved by updating the information on the coordinate conversion.

### Fourth Embodiment

In a fourth embodiment, there will be described an example of cutting the time redo the alignment when the alignment between the point cloud data fails. In the following, the differences from the third embodiment will mainly be described, while a component having the same function as that in the third embodiment will be assigned the same name and the same reference numeral as that of the third embodiment to omit the description of such component.

When an ICP method is used to update information on coordinate conversion, it is required that a default be a state where the information on the coordinate conversion is nearly estimated, namely, first point cloud data and second point cloud data are nearly aligned. This is because the ICP (Iterative Closest Point) method assumes that the coordinate systems of the point cloud data are nearly identical to each other.

While the estimation result of the information on the coordinate conversion usually satisfies this condition, it is a waste of processing time to update the information on the coordinate conversion without satisfying this condition, which as a result leads to a longer time to redo the alignment between the point cloud data. In particular, the information on the coordinate conversion is updated by using the first point cloud data and the second point cloud data being the set of points on a large scale, thereby involving an increased calculation load and requiring a longer calculation time compared to the estimation of the information on the coordinate conversion using a pair of a first focus point and a second focus point associated with each other.

Accordingly, in the fourth embodiment, the time it takes to redo the alignment between the point cloud data is cut down by redoing the estimation of the information on the coordinate conversion before updating the information on the coordinate conversion.

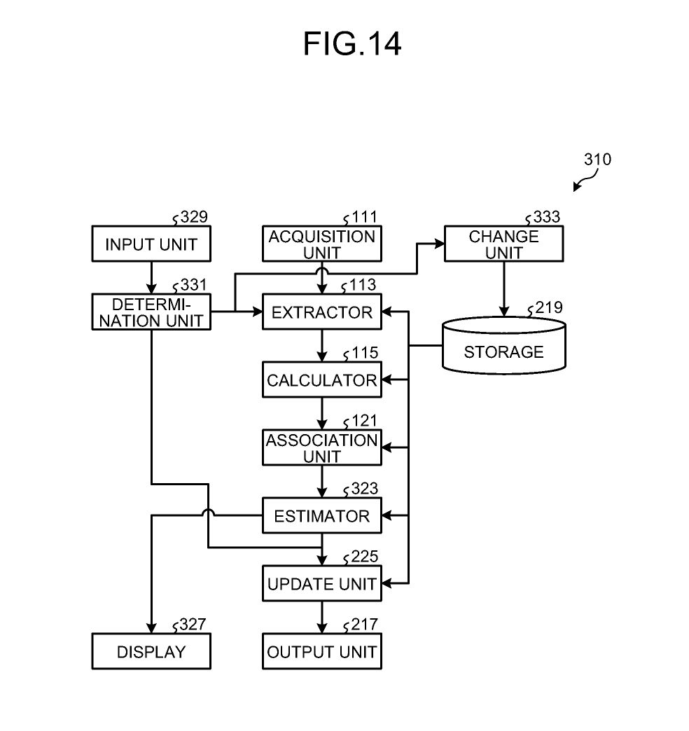

FIG. 14 is a block diagram illustrating an example of a calculation device 310 according to the fourth embodiment. As illustrated in FIG. 14, an estimator 323, a display 327, an input unit 329, a determination unit 331, and a change unit 333 included in the calculation device 310 of the fourth embodiment are different from the third embodiment.

The estimator 323 causes the display 327 to display thereon the first point cloud data and the second point cloud data that are aligned by using the estimated information on the coordinated conversion. The display 327 can be implemented by a display such as a liquid crystal display or a touch panel display.

The determination unit 331 determines whether or not to redo the estimation of the information on the coordinate conversion. Specifically, the determination unit 331 determines whether or not to redo the estimation of the information on the coordinate conversion on the basis of an input from the input unit 329 operated by a user who checks the result displayed on the display 327. The input unit 329 can be implemented by an input device such as a keyboard or a mouse.

The change unit 333 changes a parameter used by at least any of an extractor 113, a calculator 115, an association unit 121, the estimator 323, and an update unit 225 that are stored in a storage 219 when the determination unit 331 determines to redo the estimation of the information on the coordinate conversion.

The change unit 333 may change the parameter on the basis of an input from the input unit 329 operated by the user or to a preset parameter (parameter set in advance), for example.

However, the parameter used by the update unit 225 is changed when necessary as a result of the change of the parameter used by at least any of the extractor 113, the calculator 115, the association unit 121, and the estimator 323.

When the parameter is changed by the change unit 333, the process is performed over again from an extraction process by the extractor 113. Each unit performs the process over again by using the parameter changed by the change unit 333.

When the determination unit 331 determines to be settled on the estimation result of the information on the coordinate conversion, on the other hand, the update unit 225 updates the information on the coordinate conversion that is estimated by the estimator 323 in such a manner to reduce the alignment error between the first point cloud data and the second point cloud data.

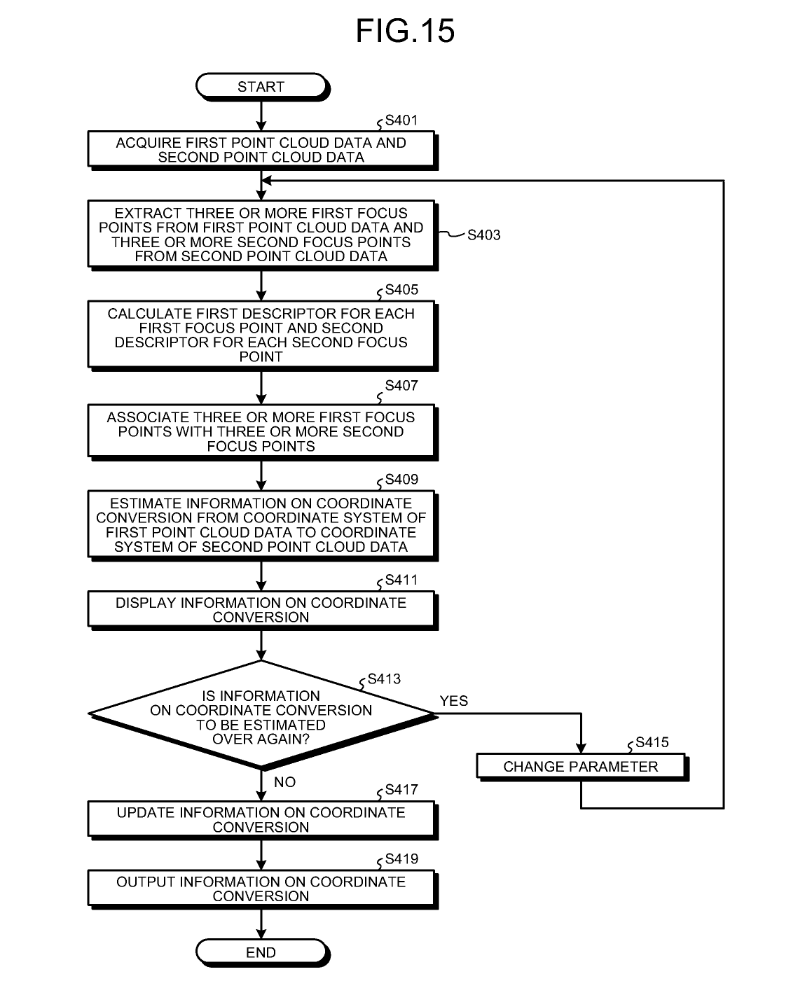

FIG. 15 is a flowchart illustrating an example of the flow of processes performed by the calculation device 310 of the fourth embodiment.

Processes performed in steps S401 to S409 are the same as the processes performed in steps S201 to S209 of the flowchart illustrated in FIG. 11, respectively.

Then, the estimator 323 causes the display 327 to display thereon the first point cloud data and the second point cloud data that are aligned by using the estimated information on the coordinate conversion (step S411).

Subsequently, the determination unit 331 determines whether or not to redo the estimation of the information on the coordinate conversion on the basis of the input from the input unit 329 operated by the user who checks the result displayed on the display 327 (step S413).

When it is determined to redo the estimation of the information on the coordinate conversion (step S413: Yes), the change unit 333 changes the parameter used by at least any of the extractor 113, the calculator 115, the association unit 121, the estimator 323, and the update unit 225 that are stored in the storage 219 (step S415). The process thereafter returns to step S403. From here on, the process in each of steps S403 to S409 and S417 is performed on the basis of the parameter being changed.

When it is determined to not redo the estimation of the information on the coordinate conversion (step S413: No), on the other hand, the update unit 225 updates the information on the coordinate conversion that is estimated by the estimator 323 in such a manner to reduce the alignment error between the first point cloud data and the second point cloud data (step S417).

Next, the output unit 217 outputs the information on the coordinate conversion that is updated by the update unit 225 (step S419).

According to the fourth embodiment, as described above, the time it takes to redo the alignment between the point cloud data can be cut by displaying the result of the alignment in which the estimated information on the coordinate conversion is used and, when the result is unfavorable, redoing the estimation of the information on the coordinate conversion by changing the parameter.

Hardware Configuration

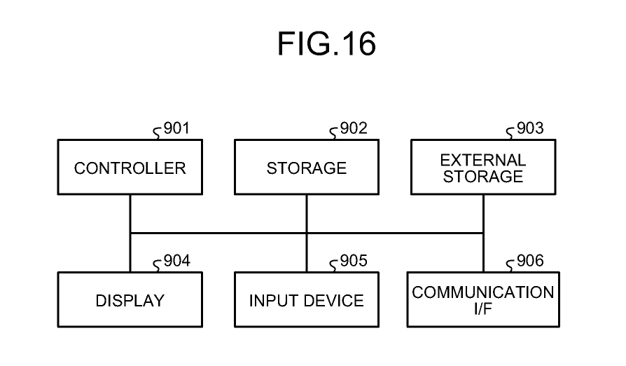

FIG. 16 is a block diagram illustrating an example of a hardware configuration of the calculation device according to each of the aforementioned embodiments. As illustrated in FIG. 16, the calculation device of each of the aforementioned embodiments includes a controller 901 such as a CPU, a storage 902 such as a ROM and a RAM, an external storage 903 such as an HDD and an SSD, a display 904 such as a display, an input device 905 such as a mouse and a keyboard, and a communication I/F 906, and can be implemented by a hardware configuration using a normal computer.

A program run by the calculation device of each of the aforementioned embodiments is provided while stored in a computer-readable storage medium such as a CD-ROM, a CD-R, a memory card, a DVD, and a flexible disk (FD) in an installable or executable file format.

The program run by the calculation device of each of the aforementioned embodiments may be provided while included in the ROM or the like in advance. Moreover, the program run by the calculation device of each of the aforementioned embodiments may be stored on a computer connected to a network such as the Internet and provided by downloading via the network. The program run by the calculation device of each of the aforementioned embodiments may also be provided or distributed via the network such as the Internet.

The program run by the calculation device of each of the aforementioned embodiments has a module configuration to implement each unit described above on the computer. Actual hardware is configured where the controller 901 reads the program from the external storage 903 to the storage 902 and runs the program so that each unit described above is implemented on the computer, for example.

Each step in the flowchart of the aforementioned embodiments may be performed in a modified order, performed such that a plurality of the steps is executed simultaneously, or performed in an order different for each execution without contradicting the nature of the step, for example.

According to each of the aforementioned embodiments, as described above, the expressiveness of the descriptor expressing the information of the vicinity of the focus point can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A calculation device comprising:
an acquisition unit that acquires point cloud data that is a set of points representing a shape of an object;
an extractor that extracts a focus point from the point cloud data;
a calculator that calculates a distance between the focus point and each of one or more neighboring points located in the vicinity of the focus point, calculates relation information which represents a relationship, not the distance, between the focus point and each of the one or more neighboring points, calculates a co-occurrence frequency between the distance and the relation information for the one or more neighboring points, and determines the co-occurrence frequency as a descriptor of the focus point; and
an output unit that outputs the descriptor.

2. The device according to claim 1, wherein the calculator calculates a plurality of types of the relation information for each of the neighboring points, calculates the co-occurrence frequency for each of pieces of the relation information of the same type, and determines the co-occurrence frequency of the plurality of types as the descriptor.

3. The device according to claim 1, wherein the relation information is a quantity based on an angle formed between a displacement vector from the focus point to the neighboring point and a normal vector at the neighboring point.

4. The device according to claim 1, wherein the relation information is similarity or dissimilarity between a feature quantity of the focus point and a feature quantity of the neighboring point.

5. The device according to claim 4, wherein the feature quantity is a normal vector.

6. The device according to claim 1, wherein
the acquisition unit acquires, as the cloud data, first cloud data and second cloud data,
the extractor extracts three or more first focus points from the first point cloud data and three or more second focus points from the second point cloud data,
the calculator calculates, as the descriptor, a first descriptor for each of the first focus points, and calculates, as the descriptor, a second descriptor for each of the second focus points, and
the device further comprises:
an association unit that uses the three or more first descriptors and the three or more second descriptors to associate the three or more first focus points with the three or more second focus points; and
an estimator that uses three or more pairs of the first focus point and the second focus point thus associated with each other to estimate information on coordinate conversion from a coordinate system of the first point cloud data to a coordinate system of the second point cloud data, and
the output unit outputs the information on coordinate conversion.

7. The device according to claim 6, wherein the association unit calculates dissimilarity between each of the three or more first descriptors and each of the three or more second descriptors to associate the three or more first focus points with the three or more second focus points.

8. The device according to claim 6, further comprising an update unit that updates the information on coordinate conversion in such a manner to reduce an alignment error between the first point cloud data and the second point cloud data, wherein
the output unit outputs the information on coordinate conversion thus updated.

9. The device according to claim 8, further comprising:
a display that displays the first point cloud data and the second point cloud data which are aligned by using the information on coordinate conversion thus estimated;
a determination unit that determines whether or not to redo estimation of the information on coordinate conversion; and
a change unit that changes a parameter used in at least one of the extractor, the calculator, the association unit, the estimator, and the update unit when the determination unit determines to redo the estimation of the information on coordinate conversion.

10. A calculation method comprising:
acquiring point cloud data that is a set of points representing a shape of an object;
extracting a focus point from the point cloud data;
calculating a distance between the focus point and each of one or more neighboring points located in the vicinity of the focus point, calculating relation information which represents a relationship, not the distance, between the focus point and each of the one or more neighboring points, calculating a co-occurrence frequency between the distance and the relation information for the one or more neighboring points, and determining the co-occurrence frequency as a descriptor of the focus point; and
outputting the descriptor.

11. A computer program product comprising a computer-readable medium containing a computer program that causes a computer to execute:
acquiring point cloud data that is a set of points representing a shape of an object;
extracting a focus point from the point cloud data;
calculating a distance between the focus point and each of one or more neighboring points located in the vicinity of the focus point, calculating relation information which represents a relationship, not the distance, between the focus point and each of the one or more neighboring points, calculating a co-occurrence frequency between the distance and the relation information for the one or more neighboring points, and determining the co-occurrence frequency as a descriptor of the focus point; and
outputting the descriptor.
